(19) United States
(12) Patent Application Publication
(10) Pub. No.: US 2025/0088131 A1
(43) Pub. Date: Mar. 13, 2025

(54) CONTROL DEVICE FOR THREE-LEVEL INVERTER, STORAGE MEDIUM, AND CONTROL METHOD FOR THREE-LEVEL INVERTER

(71) Applicant: DENSO CORPORATION, Kariya-city (JP)

(72) Inventors: Yosuke SUZUKI, Kariya-city (JP); Ken TOSHIYUKI, Kariya-city (JP)

(73) Assignee: DENSO CORPORATION, Kariya-city (JP)

(21) Appl. No.: 18/958,827

(22) Filed: Nov. 25, 2024

Related U.S. Application Data
(63) Continuation of application No. PCT/JP2023/016875, filed on Apr. 28, 2023.

(30) Foreign Application Priority Data
May 24, 2022 (JP) 2022-084852

(51) Int. Cl. H02P 27/06; H02P 21/14; H02P 21/22

(52) U.S. Cl. CPC H02P 27/06; H02P 21/14; H02P 21/22

(57) ABSTRACT

The control device of the three-level inverter is applied to a system having a first battery and a second battery, a drive object, and a three-level inverter having switches for three phases. The control device of the three-level inverter includes: a neutral point information acquisition unit that acquires neutral point information, a command voltage acquisition unit that acquires a command voltage vector to control a system output of the drive object to approach a command value, a setting unit that sets output patterns, which are combinations of output voltage vectors, each of the output voltage vectors indicating the phase-voltage for each of the three phases, that can be output by the three-level inverter, based on the command voltage vector, and a control unit that turns each of the switches on and off based on the output voltage vectors included in the output patterns.

### CROSS-REFERENCING OF RELATED APPLICATION

The present application is a continuation application of International Application No. PCT/JP2023/016875, filed on Apr. 28, 2023, which claims priority to Japanese Patent Application No. 2022-084852, filed on May 24, 2022. The contents of these applications are incorporated herein by reference in their entirety.

### 1. TECHNICAL FIELD

This disclosure relates to a control device for a three-level inverter, a storage medium, and a control method for a three-level inverter.

### 2. RELATED ART

Conventionally, as described in JPH9-37592A1, a control device is known to turn on and off switches of the three-level inverter. This control device turns the switches on and off by space vector modulation control.

The DC side of the three-level inverter is connected to a first battery and a second battery, which are connected in series. The control device controls a voltage at a neutral point between a negative electrode of the first battery and a positive electrode of the second battery to restrain overvoltage from being applied to the switch.

### SUMMARY

The present disclosure is a control device for a three-level inverter applied to a system. The system includes: a first battery and a second battery connected in series, a drive object driven by three phases AC voltage, and the three-level inverter including switches for three phases that connects each of configuration of the phases of the drive object to one of a positive electrode of the first battery, a neutral point between a negative electrode of the first battery and a positive electrode of the second battery, and a negative electrode of the second battery. The control device includes: a neutral point information acquisition unit that acquires neutral point information, a command voltage acquisition unit that acquires a command voltage vector to control a system output of the drive object to approach a command value, a setting unit that sets output patterns, which are combinations of output voltage vectors, each of the output voltage vectors indicating the phase-voltage for each of the three phases, that can be output by the three-level inverter, based on the command voltage vector, and a control unit that turns each of the switches on and off based on the output voltage vectors included in the output patterns. The control unit selects one of the two switch drive states based on neutral point information when the three-level inverter outputs a first output voltage vector. The setting unit limits a second output voltage vector to be included in the output pattern. The neutral point information is at least one of a voltage of the first battery, a voltage of the second battery, and the current flowing in each phase of the drive object. The first output voltage vector is an output voltage vector that occurs when the switches connect any one or two of the phases to the neutral point and when drive states of the switches are one of two different drive states when there are two different drive states for the same output voltage vector. The second output voltage vector is an output voltage vector that occurs when the switches connect any one of the phases and the neutral point and has a magnitude greater than that of the first output voltage vector.

### BRIEF DESCRIPTION OF THE DRAWINGS

The above and other objects, features and advantages of the present disclosure will become clearer with the following detailed description with reference to the accompanying drawings. The drawings are:

FIG. 1 shows a diagram of the motor control system;

FIG. 2 illustrates the command voltage vector;

FIG. 3 illustrates the command voltage vector;

FIG. 4 shows the current path during the period when the output voltage vector HMM is output;

FIG. 5 shows the current path during the period when the output voltage vector MLL is output;

FIG. 6 shows the division areas of limitation process;

FIG. 7 shows how output patterns are set;

FIG. 8 is a time chart showing an example of the transition of each phase-voltage during the limitation process;

FIG. 9 is a time chart showing an example of the transition of each phase-voltage during the limitation process;

FIG. 10 is a time chart showing an example of the transition of each phase-voltage during the limitation process;

FIG. 11 is a time chart showing an example of the transition of each phase-voltage during the limitation process;

FIG. 12 is a time chart showing an example of the transition of each phase-voltage during the limitation process;

FIG. 13 is a time chart showing an example of the transition of each phase-voltage during the limitation process;

FIG. 14 is a flowchart showing a control process performed by the control device;

FIG. 15 is a flowchart showing a control process performed by the control device according to the second embodiment;

FIG. 16 is a time chart showing an example of the transition of each phase-voltage during the limitation process;

FIG. 17 is a time chart showing an example of the transition of each phase-voltage during the limitation process.

### DETAILED DESCRIPTION OF THE PREFERRED EMBODIMENTS

There is concern that the controllability of the voltage at the neutral point may deteriorate depending on the drive conditions of the three-level inverter. Therefore, there is still room for improvement in the technology for controlling the voltage at the neutral point.

The purpose of this disclosure is to provide a control device for a three-level inverter that can improve the controllability of the voltage at the neutral point in view of the above circumstances.

In the drive state of the switches where at least one of the phases of the drive object and the neutral point are connected, the voltage at the neutral point can change as current flows into or out of the neutral point. During the period when the first output voltage vector is output, any one or two of the phases of the drive object and the neutral point are connected. Therefore, the voltage at the neutral point may change during the period when the first output voltage vector is output.

In this regard, in the first output voltage vector, there are two drive states of each of the switches in which the voltage applied to each phase of the drive object is the same; since the direction of change of the neutral point voltage is opposite depending on which of the two switches of the drive object is selected, the neutral point voltage or the current flowing at the neutral point also changes. It is conceivable to select one of the two drive states based on the neutral point information. In this case, the voltage at the neutral point can be controlled by appropriately selecting the drive state of the switch based on the neutral point information so that change in the voltage at the neutral point is suppressed during the output period of the first output voltage vector.

However, when the magnitude of the command voltage vector is large, the period during which the first output voltage vector is output can be shorter and the period during which the second output voltage vector is output can be longer than when the magnitude of the command voltage vector is small. The second output voltage vector is larger than the first output voltage vector. During the output period of the second output voltage vector, the switches are driven so that one of the phases of the drive object and the neutral point are connected. In this case, there is concern that the controllability of the voltage at the neutral point will be reduced.

In the present disclosure, when setting an output pattern, which is a combination of output voltage vectors, based on the command voltage vector, the inclusion of the second output voltage vector in the output pattern is limited. This suppresses the occurrence of periods during which the second output voltage vector is output. During the period when the first output voltage vector is output, one of the two drive states is selected based on the neutral point information. This allows the neutral point voltage to be controlled during the period when the first output voltage vector is output. Therefore, the change in the voltage of the neutral point can be suppressed during the period when the first output voltage vector and the second output voltage vector are output. In other words, according to the present disclosure, measures can be taken to suppress changes in the voltage at the neutral point for the output periods of the first and second output voltage vectors where there is concern that the voltage at the neutral point may change. As a result, the controllability of the voltage at the neutral point can be improved.

### First Embodiment

The first embodiment of the control device of the present disclosure will be described below with reference to the drawings. In this embodiment, the control device is installed in an electric vehicle.

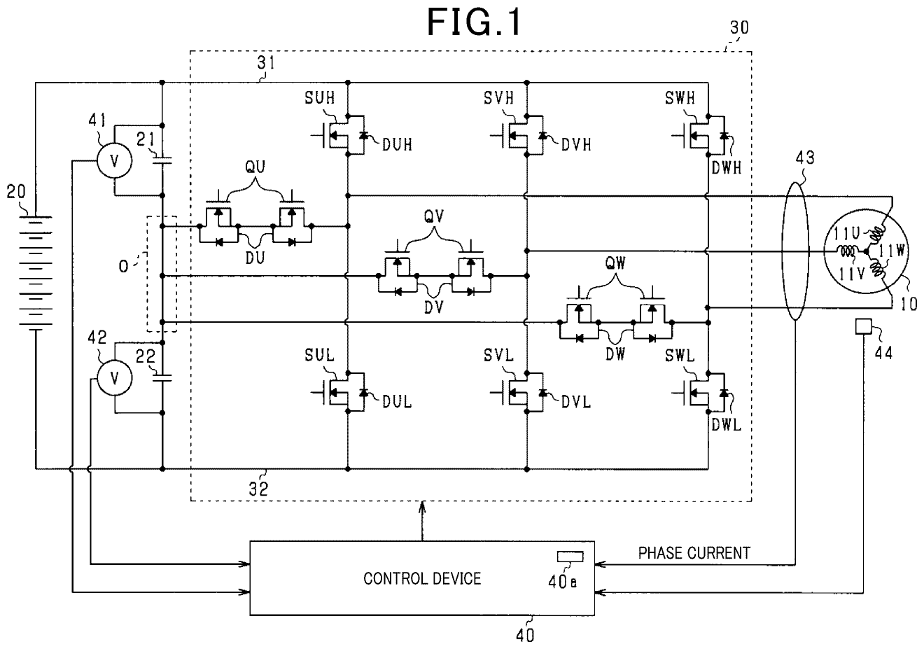

As FIG. 1 shows, the motor control system includes a motor 10, a battery 20, an inverter 30, and a control device 40. The motor 10 can transmit power to the drive wheels, which are not shown in the figure. For example, the motor 10 is a three-phase synchronous motor and includes star-connected U-phase winding 11U, 25 V-phase winding 11V, and W-phase winding 11W as stator windings. The phase windings 11U, 11V, and 11W are arranged with an offset of 120° therebetween in electrical angle. The motor 10 is, for example, a permanent magnet synchronous motor. In this embodiment, the motor 10 is an example of a “drive object”.

The battery 20 is electrically connected to the motor 10 via the inverter 30. The battery 20 may be a battery assembly including battery cells, which are single cells, for example, connected in series. The battery cell is a secondary battery such as a lithium-ion battery. A voltage VH of the battery 20 is, for example, one hundred V or higher.

The inverter 30 is a power conversion circuit that converts DC power supplied from the battery 20 to 3-phase AC power by switching operation and supplies the converted AC power to the motor 10. A first capacitor 21 and a second capacitor 22 are provided on the side of the battery 20 viewed from the inverter 30 as storage units. The first capacitor 21 and the second capacitor 22 are connected in series. The battery 20 is connected in parallel to the series connected body of the first capacitor 21 and the second capacitor 22. In this embodiment, the capacitance of the first capacitor 21 and the capacitance of the second capacitor have the same value. The first capacitor 21 and the second capacitor 22 may be external to the inverter 30 or may be built into the inverter 30.

In this embodiment, the inverter 30 is a T-type three-level inverter. The inverter 30 includes a series-connected body of the upper arm switch SUH and the lower arm switch SUL, a series-connected body of the upper arm switch SVH and the lower arm switch SVL, and a series-connected body of the upper arm switch SWH and the lower arm switch SWL, corresponding to each of the three phases. Each switch SUH to SWL is, for example, a voltage-controlled semiconductor switching device, more specifically, an N-channel MOSFET. Therefore, the high potential side terminal of each switch SUH to SWL is a drain and the low potential side terminal is a source. Each switch SUH, SVH, SWH, SUL, SVL, SWL has a corresponding body diode DUH, DVH, DWH, DUL, DVL, DWL.

The source of the phase U upper arm switch SUH is connected to the drain of the phase U lower arm switch SUL. The connection point of the phase V upper arm switch SVH and the phase V lower arm switch SVL is connected to the input terminal of phase V of the motor 10. The source of the phase W upper arm switch SWH is connected to the drain of the phase W lower arm switch SWL. The connection point between the switch SWH and the phase W lower arm switch SWL is connected to the input terminal of the phase W of the motor 10.

Each of the drains of the upper arm switches SUH to SWH is connected by a positive bus 31 such as a bus bar. The positive bus 31 is connected to the positive electrode of the battery 20 and the first end of the first capacitor 21. The second end of the first capacitor 21 is connected to the first end of the second capacitor 22 via the neutral point O. Each of the sources of the lower arm switches SUL to SWL is connected by a negative bus 32, such as a bus bar. The negative bus 32 is connected to the negative electrode the battery 20 and the second end of the second capacitor.

The inverter 30 includes clamp switches QU, QV, and QW that conduct and interrupt current in both directions. In this embodiment, voltage-controlled semiconductor switching devices are used as switches including each of the clamp switches QU to QW, specifically N-channel MOSFETs. Each switch including each of the clamp switches QU to QW has a corresponding body diode DU, DV, DW.

Specifically, the sources of each switch composing the U-phase clamp switch QU is connected to each other; the drain of one of the switches composing the U-phase clamp switch QU is connected to the connection point between the U-phase upper arm switch SUH and the U-phase lower arm switch SUL, and the drain of the other is connected to the neutral point O. The sources of each switch composing the phase-V clamp switch QV are connected to each other. Of each switch composing the phase-V clamp switch QV, one drain is connected to the junction point of the phase-V upper arm switch SVH and the phase-V lower arm switch SVL, and the other drain is connected to the neutral point O The sources of each switch composing the phase-W clamp switch QW is connected to each other, drain is connected to the neutral point O.

The motor control system includes a first voltage sensor 41, a second voltage sensor 42, a phase current sensor 43, and a rotation angle sensor 44. The first voltage sensor 41 detects the voltage between terminals of the first capacitor 21. The second voltage sensor 42 detects the voltage of the second capacitor 22. The phase current sensor 43 detects the respective U, V, and W phase currents flowing in the motor 10. The phase current sensor 43 should be able to detect at least two of the three phase currents. The rotation angle sensor 44 may be a resolver, for example, and detects the rotation angle of the motor 10. The detected values of each of the sensors 41-44 are input to the control device 40.

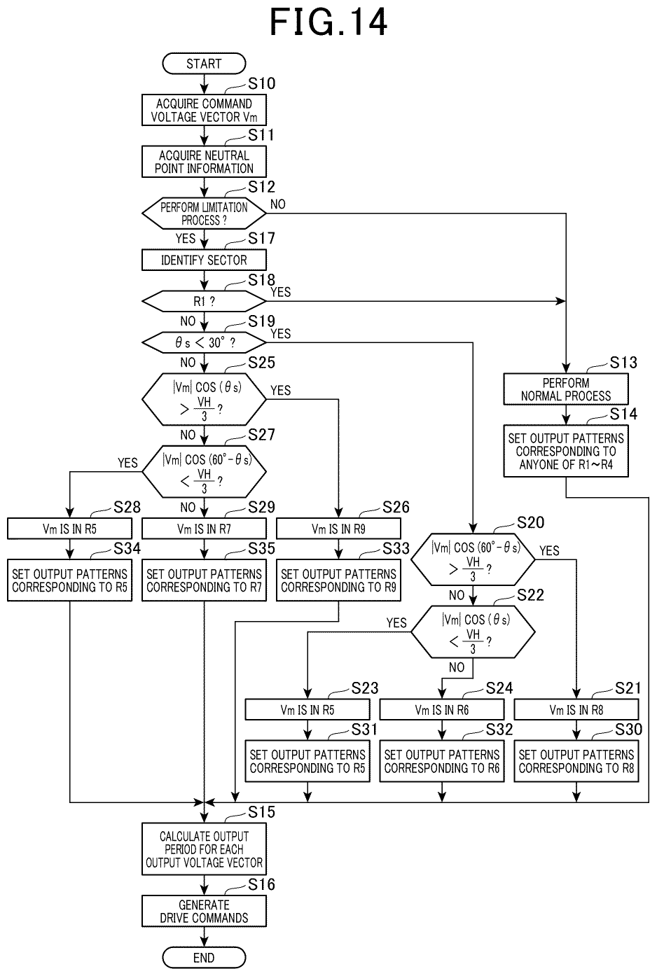

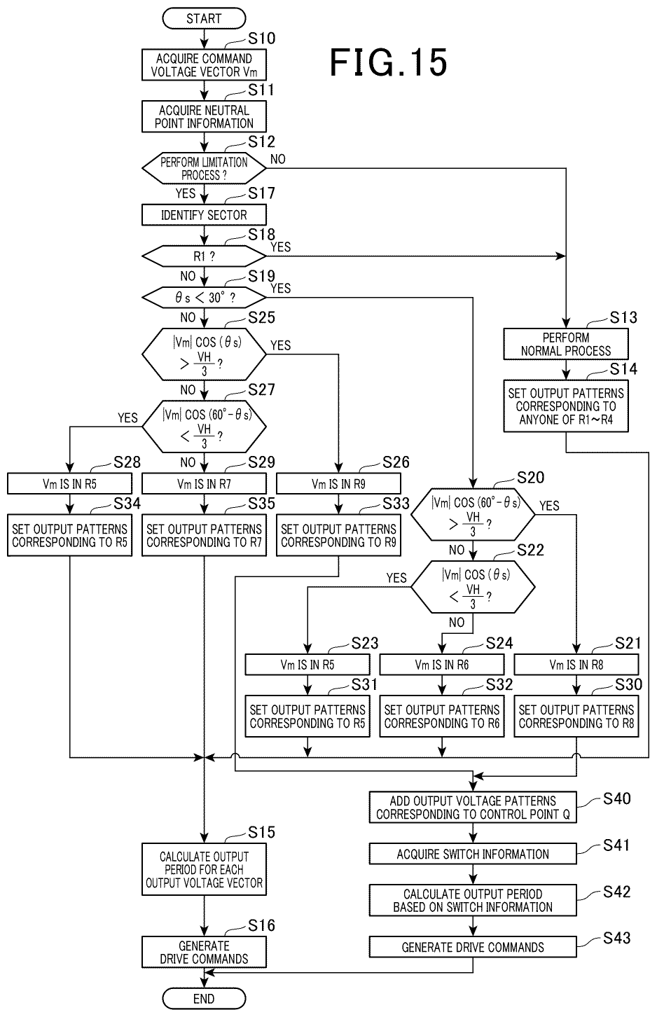

The control device 40 consists primarily of a microcomputer 40a (equivalent to a “computer”), microcomputer 40a includes a CPU. The functions provided by microcomputer 40a are provided by software recorded in a substantive memory device and the computer executing it, software only, hardware only, or a combination thereof. For example, if microcomputer 40a is provided by electronic circuits that are hardware, it is provided by digital or analog circuits that include many logic circuits. For example, microcomputer 40a executes a program stored in a non-transitory tangible storage medium as its own memory. The program includes, for example, a program for the process shown in FIGS. 14, 15, etc. When the program is executed, the method corresponding to the program is performed. The storage section is, for example, a nonvolatile memory. The program stored in the memory section can be updated via a network, such as the Internet, for example.

The control device 40 generates drive commands to turn on and off each switch SUH to SWL, QU to QW of the inverter 30 by space vector modulation control. The control device 40 turns on and off each switch SUH to SWL, QU to QW based on the drive commands. The process of generating drive commands for each switch SUH to SWL, QU to QW by control device 40 is described below.

The control device 40 acquires a command voltage vector to control the system output of the drive object close to approach a command value. In this embodiment, the control device 40 acquires the command voltage vector Vm to control the torque of the motor 10 to approach the command torque. The control device 40 calculates a manipulated variable of feedback control to bring the rotation speed of the rotor of the motor 10 closer to the calculated command rotation speed. The command torque is calculated as the rotation speed of the rotor of the motor 10 based on the detected value of the rotation angle sensor 44.

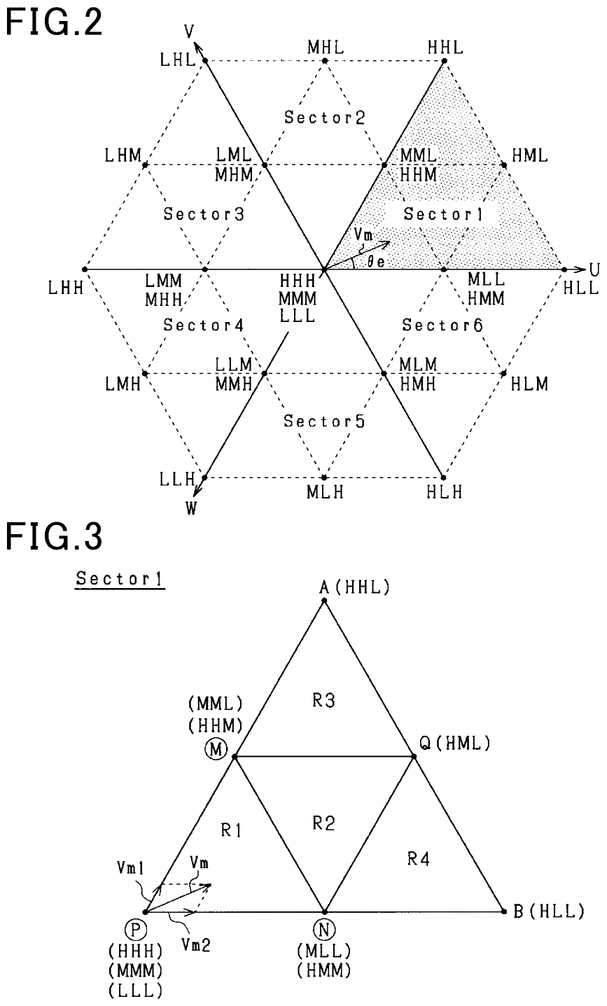

Next, the command voltage vector Vm is explained, using FIGS. 2 and 3. As FIG. 2 shows, the command voltage vector Vm is represented as a spatial voltage vector whose components are the U, V, and W phase-voltages applied to the motor 10. The axes of the U, V, and W phases are displaced by 120° at an electrical angle.

In FIG. 2, the output voltage vector that can be output by the inverter 30 out of the spatial voltage vector is indicated as a component by each phase-voltage group. Each phase-voltage of the output voltage vector is represented by three levels H, M, and L. The output voltage vectors represented by three letters of the alphabet are, from left to right, phase-voltage of phase U, phase-voltage of phase V, and phase-voltage of phase W in three levels. The phase-voltage of level His the phase-voltage that is output when the input terminals of each phase and the corresponding upper arm switches SUH to SWH are connected. The phase-voltage of level M is the phase-voltage that is output when the input terminals of each phase and the corresponding clamp switches QU to QW are connected. The phase-voltage of level L is the phase-voltage that is output when the input terminals of each phase and the corresponding lower arm switches SUL to SWL are connected. For example, the output voltage vector HML represents that the U phase-voltage is level H, the V phase-voltage is level M, and the W phase-voltage is level L.

When there is no change in the voltage at the neutral point O, the phase-voltage of level H is VH, the phase-voltage of level M is VH/2, and the phase-voltage of level L is 0. Each phase-voltage is the potential of the input terminal of the respective phase when the potential of the negative electrode of the battery 20 is defined as the reference potential (0V).

The control device 40 identifies the area where the command voltage vector Vm exists. In this embodiment, the control device 40 identifies sectors and division areas where the command voltage vector Vm exists. The sectors and the division areas are used to set the output patterns described below.

The control device 40 identifies the sector in which the command voltage vector Vm exists based on the electrical angle de of the command voltage vector Vm. The electrical angle θe is an angle between the command voltage vector Vm and the U-phase axis line. The electrical angle θe takes values from 0° to 360°. The sign of the electrical angle de is defined as leftward (counterclockwise) to be positive. The vector space in which the command voltage vector Vm can exist is divided into six sectors with respect to the electrical angle de. The control device 40 identifies the command voltage vector Vm as residing in the first sector when 0°≤θe<60° and identifies the command voltage vector Vm as residing in the second sector when 60°≤θe<120°. The control device 40 identifies the command voltage vector Vm as being in the third sector when 120°≤θe<180°, and the control device 40 identifies the command voltage vector Vm as being in the fourth sector when 180°≤θe<240°. The control device 40 identifies the command voltage vector Vm as being in the fifth sector when 240°≤θe<300° and the control device 40 identifies the command voltage vector Vm as being in the sixth sector when 300°≤θe<360°. As an example in FIG. 2, a dot hatch is applied to the region indicating the first sector.

The first through sixth sectors are equilateral triangles in shape, and each sector has its own control points A, B, M, N, P, and Q. The control point P is the origin in FIG. 2 and a starting point of the command voltage vector Vm. The control points A and B are points at the vertex of each sector. The control point M is a point provided at the midpoint of the control point A and the control point P. The control point N is located at the midpoint of the control point B and the control point P. The control point Q is located at the midpoint of the control point A and the control point B.

FIG. 3 shows the relationship between each of the control points A, B, M, N, P, Q and each output voltage vector established for the first sector. The output voltage vectors which starting point and ending point are the control point P are the output voltage vectors HHH, MMM, and LLL, which correspond to the reactive voltage vectors. The output voltage vector with the control point P as the starting point and the control point Q as the end point is the output voltage vector HML. The output voltage vector with the control point P as the starting point and the control point A as the end point is the output voltage vector HHL. The output voltage vector with the control point P as the starting point and the control point B as the end point is the output voltage vector HLL. The output voltage vectors with the control point P as the starting point and the control point M as the end point are output voltage vectors HHM and MML. The output voltage vectors with the control point P as the starting point and the control point N as the end point are output voltage vectors HMM and MLL.

As in the case of the first sector, the relationship between each of the control points A, B, M, N, P, and Q and each output voltage vector is defined for the second through sixth sectors. In the second sector, the output voltage vector with the control point P as the starting point and the control point Q as the end point is the output voltage vector MHL. The output voltage vector with the control point P as the starting point and the control point A as the end point is the output voltage vector LHL. The output voltage vector with the control point P as the starting point and the control point B as the end point is the output voltage vector HHL. The output voltage vectors with the control point P as the starting point and the control point M as the end point are output voltage vectors MHM and LML. The output voltage vectors with the control point P as the starting point and the control point N as the end point are output voltage vectors HHM and MML.

In the third sector, the output voltage vector with the control point P as the starting point and the control point Q as the end point is the output voltage vector LHM. The output voltage vector with the control point P as the starting point and the control point A as the end point is the output voltage vector LHH. The output voltage vector with the control point P as the starting point and the control point B as the end point is the output voltage vector LHL. The output voltage vectors with the control point P as the starting point and the control point M as the end point are output voltage vectors MMH and LMM. The output voltage vectors with the control point P as the starting point and the control point N as the end point are output voltage vectors MHM and LML.

In the fourth sector, the output voltage vector with the control point P as the starting point and the control point Q as the end point is the output voltage vector LMH. The output voltage vector with the control point P as the starting point and the control point A as the end point is the output voltage vector LLH. The output voltage vector with the control point P as the starting point and the control point B as the end point is the output voltage vector LHH. The output voltage vectors with the control point P as the starting point and the control point M as the end point are output voltage vectors MMH and LLM. The output voltage vectors with the control point P as the starting point and the control point N as the end point are output voltage vectors MHH and LMM.

In the fifth sector, the output voltage vector with the control point P as the starting point and the control point Q as the end point is the output voltage vector MLH. The output voltage vector with the control point P as the starting point and the control point A as the end point is the output voltage vector HLH. The output voltage vector with the control point P as the starting point and the control point B as the end point is the output voltage vector LLH. The output voltage vectors with the control point P as the starting point and the control point M as the end point are output voltage vectors HMH and MLM. The output voltage vectors with the control point P as the starting point and the control point N as the end point are output voltage vectors MMH and LLM.

In the sixth sector, the output voltage vector with the control point P as the starting point and the control point Q as the end point is the output voltage vector HLM. The output voltage vector with the control point P as the starting point and the control point A as the end point is the output voltage vector HLL. The output voltage vector with the control point P as the starting point and the control point B as the end point is the output voltage vector HLH. The output voltage vectors with the control point P as the starting point and the control point M as the end point are output voltage vectors HMM and MLL. The output voltage vectors with the control point P as the starting point and the control point N as the end point are output voltage vectors HMH and MLM.

The control device 40 identifies the division area in the sector where the command voltage vector Vm exists based on the magnitude of the command voltage vector Vm and the electrical angle de. The division area is an area defined based on each control point A, B, M, N, P, and Q established for each of the first through sixth sectors.

The first division area R1 is an area bounded by an equilateral triangle with each control point P, M, N as a vertex. The second division area R2 is an area bounded by an equilateral triangle with each control point M, N, Q as a vertex. The third division area R3 is an area bounded by an equilateral triangle with each control point A, M, Q as a vertex. The fourth division area R4 is an area bounded by an equilateral triangle with each control point B, N, Q as a vertex.

For example, control device 40 may use information (specifically, map information or formula information) in which the magnitude and electrical angle θe of the command voltage vector Vm are mapped to each of the division areas R1-R4 for the first through sixth sectors to identify the division areas where the command voltage vector Vm exists.

The control device 40 sets the output pattern, which is a combination of output voltage vectors, based on the division area where the command voltage vector Vm exists. The control device 40 sets the output voltage vector corresponding to the control point at the vertex of the division area where the command voltage vector Vm exists, included in the output pattern. For example, as shown in FIG. 3, when the control device 40 identifies that the command voltage vector Vm is in the first division area R1, the control device 40 includes the output voltage vector corresponding to each control point P, M, N in the output pattern.

The control device 40 decomposes the command voltage vector Vm into output voltage vectors included in the output pattern. The control device 40 calculates the output period in one modulation cycle of the corresponding output voltage vector based on the magnitude of the decomposed output voltage vector. The control device 40 generates drive commands to turn on and off each of the switches SUH to SWL and QU to QW of the inverter 30 based on the calculated output period.

For example, as FIG. 3 shows, when the command voltage vector Vm is identified as being in the first division area R1, the command voltage vector Vm is decomposed into output voltage vectors corresponding to each of the control points M, N. In FIG. 3, Vm1 is a vector in which the output voltage vector corresponding to the control point M is multiplied by α (0<α<1), and Vm2 is a vector in which the output voltage vector corresponding to the control point N is multiplied by β (0<β<1). The larger the coefficient α, the longer the output period of the output voltage vector corresponding to control point M in one modulation cycle. The larger the coefficient β, the longer the output period of the output voltage vector corresponding to control point N becomes in one modulation cycle. 1 modulation cycle is set to the output period of the reactive voltage vector except the period corresponding to coefficient α and the period corresponding to coefficient β.

When the neutral point O is connected to input terminal of at least one phase of each phase of the motor 10, the voltage at the neutral point O can change as current flows into or out of the neutral point O. Therefore, the voltage at neutral point O may change during the output period of the output voltage vector corresponding to each of the control points M, N, Q.

In the output voltage vector corresponding to each of the control points M, N, there are two drive states for each of the switches SUH-SWL, QU-QW. In detail, the output voltage vector corresponding to each of the control points M, N has a Hi-Mid drive state and a Mid-Lo drive state. The Mid-Lo drive state is a drive state in which one of the lower arm switches SUL to SWL and one of the clamp switches QU to QW are turned on and one of the upper arm switches SUH to SWH and one of the lower arm switches SUL to SWL are turned off. The Mid-Lo drive state is a drive state in which each of the lower arm switches SUL to SWL and one of the clamp switches QU to QW are turned on and each of the upper arm switches SUH to SWH are turned off.

For example, as FIG. 3 shows, the output voltage vectors corresponding to the control point N in the first sector are the output voltage vectors HMM and MLL. During the period when the output voltage vector HMM is output, the U-phase upper arm switch SUH and the V, W-phase clamp switches QV, QW are turned on as the Hi-Mid drive state, and the phase V, phase W upper arm switches SVH, SWH, each phase lower arm switch SUL to SWL and U-phase clamp switch QU are turned off.

On the other hand, during the period when the output voltage vector MLL is output, the phase U clamp switch QU and the phase-V, phase-W lower arm switches SVL, SWL are turned on as the Mid-Lo drive state, and the phase-U upper arm switches SUH to SWH, phase U lower arm switch SUL and phase V, phase W clamp switches QV and QW are turned off. In this system, the output voltage vector corresponding to control point M or control point N is an example of the “first output voltage vector”.

The direction of the voltage change at the neutral point O is opposite in the Hi-Mid drive state and the Mid-Lo drive state. The direction of the voltage change at neutral point O is opposite during the output period of output voltage vector MLL, which is the Mid-Lo drive state.

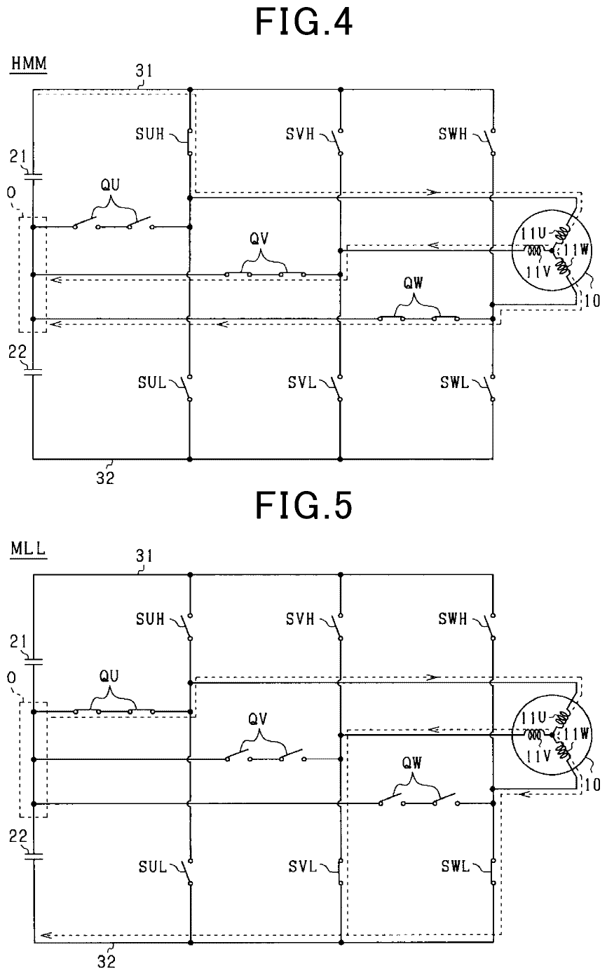

Specifically, as FIG. 4 shows, the current path during the period when the output voltage vector HMM is output is: the first capacitor 21→the positive bus 31→the phase U upper arm switch SUH→the phase U winding 11U→the phase V, W winding 11V, 11W→the phase V, W clamp switches QV, QW→the neutral point O. This causes current to flow into neutral point O, thus increasing the voltage at neutral point O.

As FIG. 5 shows, the current path during the period when the output voltage vector MLL is output is: the neutral point O→the phase U clamp switch QU→the phase U winding 11U→the phase V, W windings 11V, 11W→the phase V, W lower arm switches SVL, SWL→the negative bus 32→the second capacitor 22. This causes the current to flow out of the neutral point O, thus reducing the voltage at the neutral point O.

During the period when the output voltage vectors corresponding to each of the control point M and N are output, it is conceivable to control the neutral point voltage by appropriately selecting one of the Hi-Mid drive state and the Mid-Lo drive state. Therefore, the control device 40 acquires the neutral point information, which is at least one of the detected value of the first voltage sensor 41, the detected value of the second voltage sensor 42, and the detected value of the phase current sensor 43. In this embodiment, the neutral point information includes all of the detection value of the first voltage sensor 41, the detection value of the second voltage sensor 42, and the detection value of the phase current sensor 43.

When the output voltage vector corresponding to each control point M, Nis output, the control device 40 selects one of the Hi-Mid drive state and the Mid-Lo drive state based on the neutral point information. One of the two states is selected based on the neutral point information. For example, the control device 40 determines that the voltage at the neutral point O is rising when the voltage of the first capacitor 21 detected by the first voltage sensor 41 is lower than the voltage of the second capacitor 22 detected by the second voltage sensor 42. In this case, the control device 40 selects the drive state that decreases the voltage of the neutral point O among the Hi-Mid drive state and the Mid-Lo drive state when the output voltage vector corresponding to each of the control point M, N is output. On the other hand, the control device 40 determines that the voltage at the neutral point O is decreasing when the voltage of the first capacitor 21 detected by the first voltage sensor 41 is higher than the voltage of the second capacitor 22 detected by the second voltage sensor 42. In this case, the control device 40 selects the drive state that increases the voltage of the neutral point O among the Hi-Mid drive state and the Mid-Lo drive state when the output voltage vector corresponding to each of the control point M, N is output.

For example, the control device 40 calculates the voltage at the neutral point O based on the detected value of each of the phase current sensor 43. The control device 40 determines that the voltage at the neutral point O is increasing or decreasing based on the calculated voltage at the neutral point O and selects one of the Hi-Mid drive state and Mid-Lo drive state. The control device 40 calculates the amount of electric charge flowing into or out of the neutral point O by integrating the detected values of the phase current sensor 43. The control device 40 calculates the amount of electric charge flowing into or out of the neutral point O, the capacitance of the first capacitor 21 and the second capacitor 22.

However, when the magnitude of the command voltage vector Vm is large, the output period of the output voltage vector corresponding to each of the control point M, N can be shorter and the output period of the output voltage vector corresponding to control point Q can be longer than when the magnitude of the command voltage vector Vm is small. Here, the output voltage vector corresponding to the control point Q is an output voltage vector that is larger than the magnitude of the output voltage vectors corresponding to each of the control point M, N. During the period when the output voltage vector corresponding to the control point Q is output, the neutral point O is connected to one of the input terminals of each phase of the motor 10. In this case, there is concern that the controllability of the voltage at neutral point O may be reduced. In this embodiment, the output voltage vector corresponding to the control point Q corresponds to the “second output voltage vector”.

In this embodiment, the control device 40 selects and performs one of a normal process and a limitation process. The normal process is a process in which the output voltage vector corresponding to the control point at the vertex of the first to fourth segmented areas R1 to R4 is set as the output pattern, as described above. The limitation process is a process in which the output voltage vector corresponding to control point Q is limited to be set as the output pattern. The following is a detailed explanation of the limitation process.

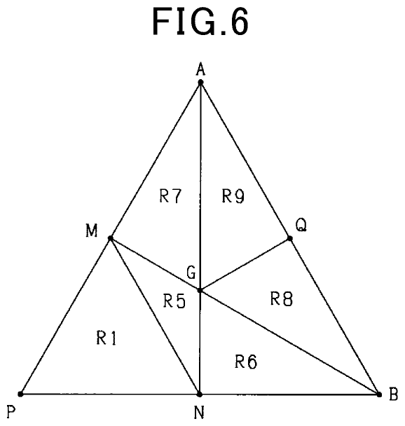

In the limitation process, the division method of the areas corresponding to the second to fourth division areas R2 to R4 in the normal process is changed. FIG. 6 shows the division areas in limitation process. In the limitation process, the first, the fifth to the ninth division areas R1, R5 to R9 are defined for each of the first to sixth sectors. In FIG. 6, for convenience, the center of gravity of the equilateral triangle bounded by each control point P, A, and B is shown as a point G. The point G is the point that divides line segment PQ into 2:1. In FIG. 6, the configuration shown in FIG. 3 is marked with the same symbol for convenience.

The fifth division area R5 is an area bounded by a triangle with each of the control points M, N and the point G as vertices. The sixth division area R6 is an area bounded by a triangle with each of the control points B, N and the point G as vertices. The seventh division area R7 is an area bounded by a triangle with each of the control points A, M and the point G as vertices. The eighth division area R8 is an area bounded by triangle with each of the control points B, Q and the point G as vertices. The ninth division area R9 is an area bounded by the triangle with each of the control points A, Q and the point G as vertices.

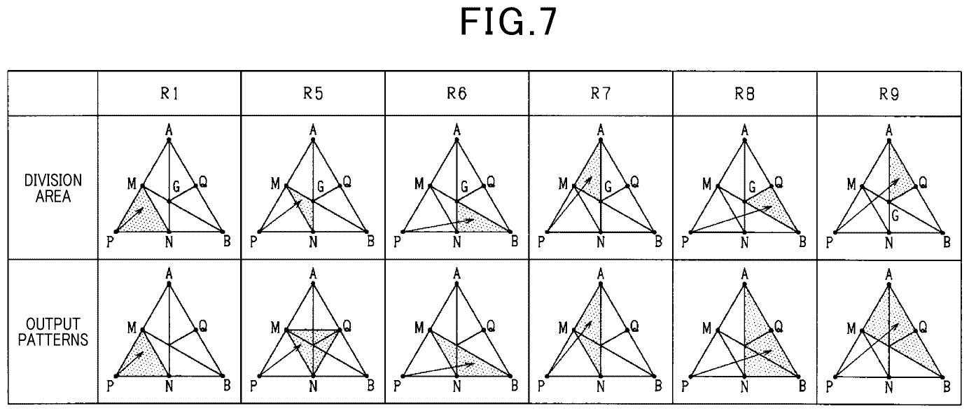

The control device 40 limits the output voltage vector corresponding to the control point Q to be included in the output pattern when the limitation process is performed. Specifically, the control device 40 sets the output pattern for the first, the fifth through the ninth divisional areas R1, R5 through R9 as FIG. 7 shows. When the command voltage vector Vm is identified as being in the first division area R1, the output pattern includes output voltage vectors corresponding to each of the control points P, M, N. When the command voltage vector Vm is identified as being in the fifth division area R5, the output pattern includes the output voltage vector corresponding to each of the control points M, N, Q.

The sixth to the ninth division areas R6 to R9 are areas bordering one of the control points A and B. Here, the output voltage vectors corresponding to each of the control points A, B are larger than the magnitude of the output voltage vectors corresponding to each of the control points M, N. In the output period of the output voltage vector corresponding to each of the control points A, B, the drive state of each of the switches SUH to SWL, QU to QW is a drive state in which the neutral point O and any input terminals of each phase of the motor 10 are not connected. When the command voltage vector Vm is identified as being in one of the sixth to the ninth division areas R6 to R9, the output pattern includes the output voltage vectors corresponding to any three of the respective control points A, B, M and N. This limits the output voltage vector corresponding to the control point Q to be included in the output pattern. In this pattern, the output voltage vector corresponding to each of the control point A, B is an example of the “third output voltage vector”.

When the output of the output voltage vector corresponding to the control point Q is limited, it is desirable that the output period of the output voltage vector corresponding to each of the control points A, B be lengthened to suppress the loss of controllability of the inverter 30 when the magnitude of the command voltage vector Vm is increased. On the other hand, to suppress changes in the voltage at the neutral point O, it is desirable that the output period of the output voltage vector corresponding to each of the control points M, N be lengthened.

In this embodiment, the method of setting the output pattern including any three of the output voltage vectors corresponding to each of the control points A, B, M, N is changed according to which of the sixth to the ninth divisional areas R6 to R9 is the area of existence of the command voltage vector Vm. When the command voltage vector Vm is identified as being in the sixth and the seventh division areas R6 and R7, the output of the motor 10 can be lower than when the command voltage vector Vm is identified as being in the eighth and the ninth division areas R8 and R9. In this case, the output pattern is a combination of the output voltage vector corresponding to one of the respective control points A and B, the output voltage vector corresponding to the control point M, and the output voltage vector corresponding to the control point N. When the command voltage vector Vm is identified as being in the eighth and the ninth division areas R8 and R9, the output of the motor 10 can be higher than when the command voltage vector Vm is identified as being in the sixth and the seventh division areas R6 and R7. In this case, the output pattern is a combination of the output voltage vector corresponding to one of the respective control points M, N, the output voltage vector corresponding to the control point A, and the output voltage vector corresponding to the control point B.

Specifically, when the command voltage vector Vm is identified as being in the sixth division area R6, an output pattern that is a combination of output voltage vectors corresponding to each of the control points B, M, and N is set. When the command voltage vector Vm is identified as being in the seventh division area R7, the output pattern, which is a combination of output voltage vectors corresponding to each of the control points A, M, N, is set. When the command voltage vector Vm is identified as being in the eighth division area R8, the output pattern, which is a combination of output voltage vectors corresponding to each of the control points A, B, N, is set. When the command voltage vector Vm is identified as being in the ninth division area R9, the output pattern, which is a combination of output voltage vectors corresponding to each of the control points A, B, M, is set. In this embodiment, the sixth and the seventh division areas R6 and R7 are examples of “low output areas” and the eighth and the ninth division areas R8 and R9 are examples of “high output areas”.

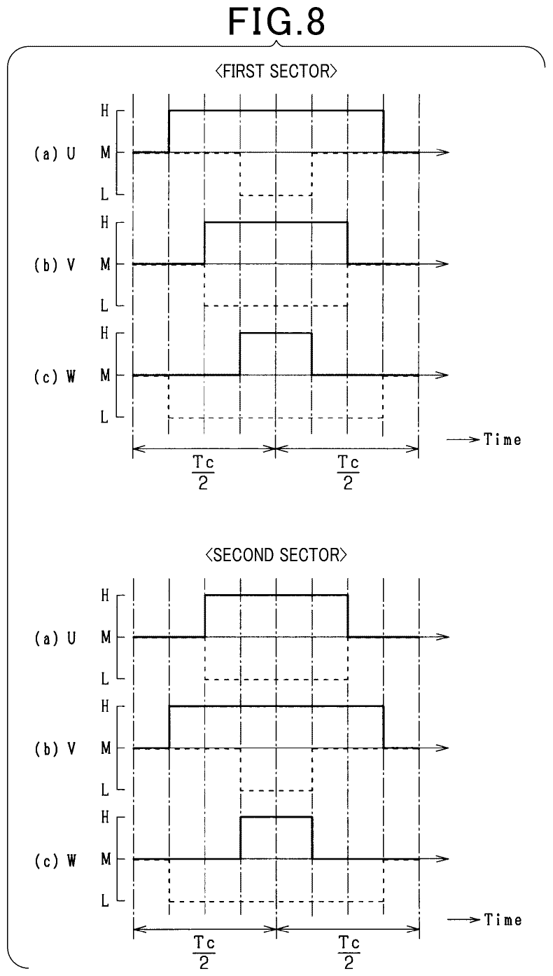

FIGS. 8 to 13 show examples of the transition of each of the phase-voltage levels in the limitation process. In FIGS. 8 to 13, (a) part shows the transition of the phase-voltage level of phase U, (b) part shows the transition of the phase-voltage level of phase V, and (c) part shows the transition of the phase-voltage level of phase W. FIGS. 8 to 13 show the transition of each of the phase-voltage levels in one modulation cycle Tc. In the transition of each of the phase-voltage levels shown by FIGS. 8 to 13, the transition of each phase-voltage level in the second half of one modulation cycle Tc is a reversed transition of each of the phase-voltage levels in the first half of one modulation cycle Tc.

When the command voltage vector Vm is in the first division area R1 of the first sector or the second sector, depending on whether the Hi-Mid or Mid-Lo drive state is selected, the output voltage vector in the first half of one modulation cycle Tc is in the following order. When the Hi-Mid drive state is selected in the first sector, the output voltage vectors are output in the order of MMM, HMM, HHM, and HHH. When the Hi-Mid drive state is selected in the second sector, the output voltage vectors are output in the order of MMM, MHM, HHM, and HHH. In these cases, the transition of each of the phase-voltage levels is shown by the solid line in FIG. 8. When the Mid-Lo drive state is selected in the first sector, the output voltage vectors are output in the order of MMM, MML, MLL, and LLL. When the Mid-Lo drive state is selected in the second sector, the output voltage vectors are output in the order of MMM, MML, LML, and LLL. In these cases, the transition of each of the phase-voltage levels is shown by the dashed line in FIG. 8.

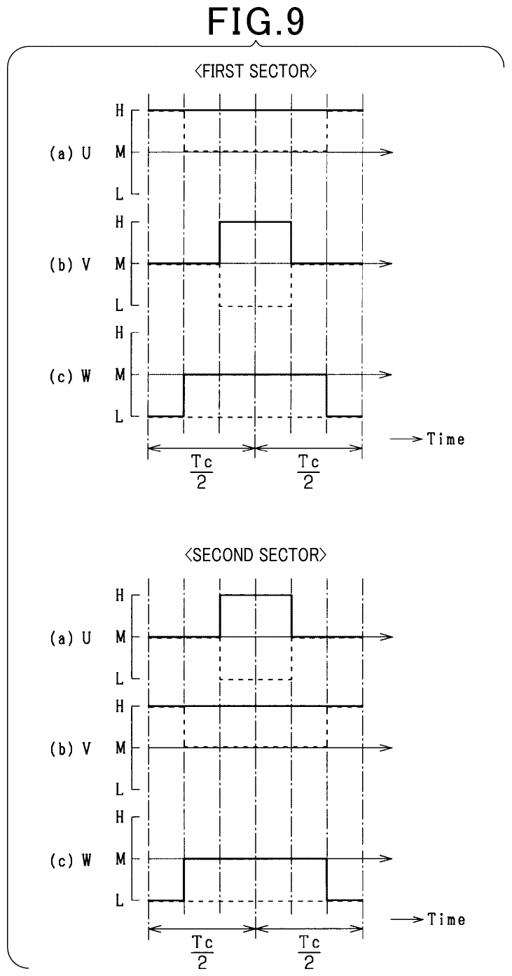

When the command voltage vector Vm is in the fifth division area R5 of the first sector or the second sector, depending on whether the Hi-Mid or Mid-Lo drive state is selected, the output voltage vector in the first half of one modulation cycle Tc is in the following order. When the Hi-Mid drive state is selected in the first sector, the output voltage vectors are output in the order of HML, HMM, and HHM. When the Hi-Mid drive state is selected in the second sector, the output voltage vectors are output in the order of MHL, MHM, HHM. In these cases, the transition of each of the phase-voltage levels becomes the transition shown by the solid line in FIG. 9. When the Mid-Lo drive state is selected in the first sector, the output voltage vectors are output in the order of HML, MML, and MLL. When the Mid-Lo drive state is selected in the second sector, the output voltage vectors are output in the order of MHL, MML, and LML. In these cases, the transition of each of the phase-voltage levels is shown by the dashed line in FIG. 9.

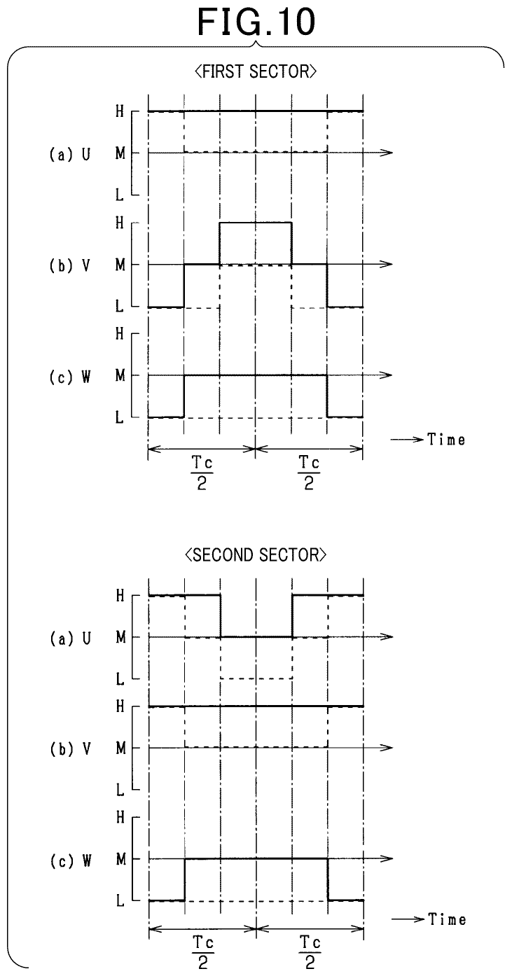

When the command voltage vector Vm is in the sixth division area R6 of the first sector or the second sector, depending on whether the Hi-Mid or Mid-Lo drive state is selected, the output voltage vector in the first half of one modulation cycle Tc is in the following order. When the Hi-Mid drive state is selected in the first sector, the output voltage vectors are output in the order of HLL, HMM, and HHM. When the Hi-Mid drive state is selected in the second sector, the output voltage vectors are output in the order of HHL, HHM, and MHM. In these cases, the transition of each of the phase-voltage levels becomes the transition shown by the solid line in FIG. 10. When the Mid-Lo drive state is selected in the first sector, the output voltage vectors are output in the order of HLL, MLL, and MML. When the Mid-Lo drive state is selected in the second sector, the output voltage vectors are output in the order HHL, MML, and LML. In these cases, the transition of each of the phase-voltage levels is shown by the dashed line in FIG. 10.

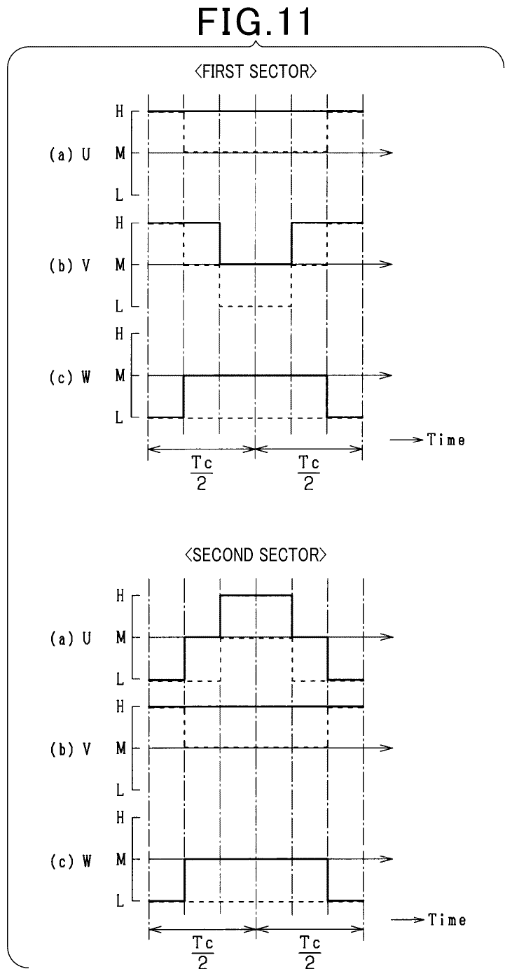

When the command voltage vector Vm is in the seventh division area R7 of the first sector or the second sector, depending on whether the Hi-Mid or Mid-Lo drive state is selected, the output voltage vector in the first half of one modulation cycle Tc is in the following order. When the Hi-Mid drive state is selected in the first sector, the output voltage vectors are output in the order of HHL, HHM, and HMM. When the Hi-Mid drive state is selected in the second sector, the output voltage vectors are output in the order of LHL, MHM, and HHM. In these cases, the transition of each of the phase-voltage levels becomes the transition shown by the solid line in FIG. 11. When the Mid-Lo drive state is selected in the first sector, the output voltage vectors are output in the order of HHL, MML, and MLL. When the Mid-Lo drive state is selected in the second sector, the output voltage vectors are output in the order of LHL, LML, and MML. In these cases, the transition of each of the phase-voltage levels is shown by the dashed line in FIG. 11.

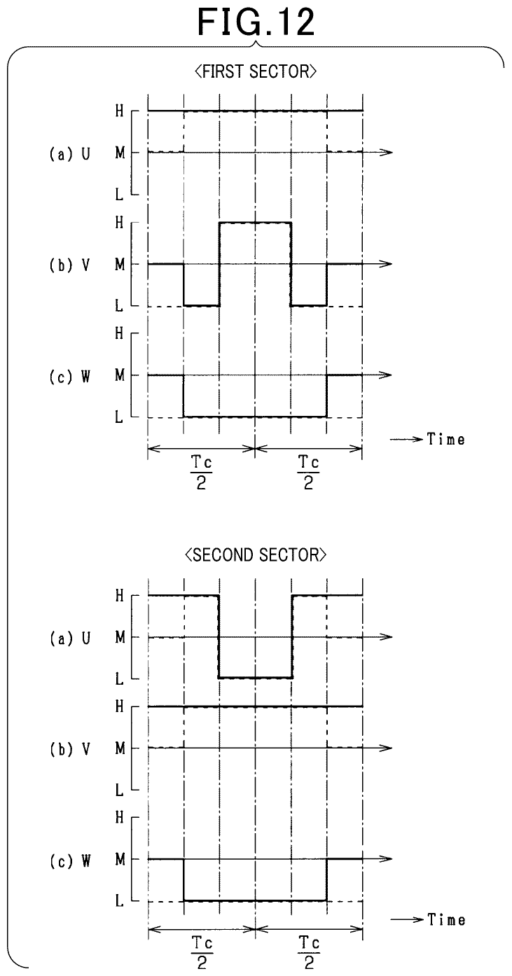

When the command voltage vector Vm is in the eighth division area R8 of the first or the second sector, depending on whether the Hi-Mid or Mid-Lo drive state is selected, the output voltage vector in the first half of one modulation cycle Tc is in the following order. When the Hi-Mid drive state is selected in the first sector, the output voltage vectors are output in the order of HMM, HLL, and HHL. When the Hi-Mid drive state is selected in the second sector, the output voltage vectors are output in the order of HHM, HHL, and LHL. In these cases, the transition of each of the phase-voltage levels becomes the transition shown by the solid line in FIG. 12. When the Mid-Lo drive state is selected in the first sector, the output voltage vectors are output in the order of MLL, HLL, and HHL. When the Mid-Lo drive state is selected in the second sector, the output voltage vectors are output in the order of MML, HHL, and LHL. In these cases, the transition of each of the phase-voltage levels is shown by the dashed line in FIG. 12.

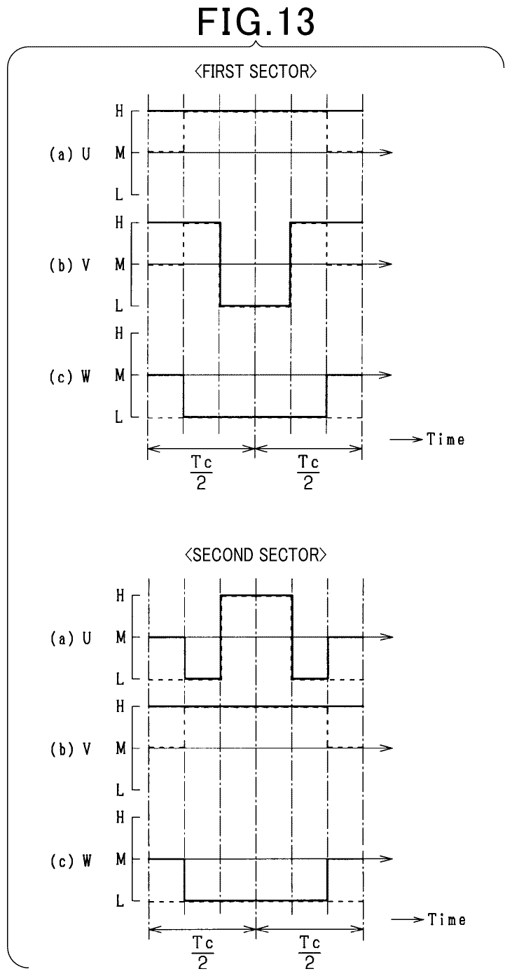

When the command voltage vector Vm is in the 9th division area R9 of the first sector or the second sector, depending on whether the Hi-Mid or Mid-Lo drive state is selected, the output voltage vector is output in the following order in the first half of one modulation cycle Tc. When the Hi-Mid drive state is selected in the first sector, the output voltage vectors are output in the order of HHM, HHL, and HLL. When the Hi-Mid drive state is selected in the second sector, the output voltage vectors are output in the order of MHM, LHL, and HHL. In these cases, the transition of each of the phase-voltage levels becomes the transition shown by the solid line in FIG. 13. When the Mid-Lo drive state is selected in the first sector, the output voltage vectors are output in the order of MML, HHL, and HLL. When the Mid-Lo drive state is selected in the second sector, the output voltage vectors are output in the order of LML, LHL, and HHL. In these cases, the transition of each of the phase-voltage levels is shown by the dashed line in FIG. 13.

FIG. 14 shows the control procedure performed by control device 40. This control, for example, may be performed repeatedly in each control cycle.

In step S10, the control device 40 acquires the command voltage vector Vm. In step S11, control device 40 acquires the neutral point information. In this embodiment, the detection value of the first voltage sensor 41, the detection value of the second voltage sensor 42, and the detection value of the phase current sensor 43 are acquired as neutral point information. Step S10 corresponds to the “command voltage acquisition unit” and step S11 corresponds to the “neutral point information acquisition unit”.

In step S12, the control device 40 determines whether to perform limitation process based on the neutral point information. In this embodiment, the control device 40 determines to perform limitation process when the control device 40 has determined that the voltage at the neutral point O exceeds the allowable range and does not decide to perform limitation process when the control device 40 has not determined that the voltage at the neutral point O exceeds the allowable range. For example, the voltage at the neutral point O may be calculated based on the detection value of the phase current sensor 43, the capacitance of the first capacitor 21 and the capacitance of the second capacitor 22. For example, the control device 40 may determine that the voltage at the neutral point O exceeds the allowable range when either the voltage of the first capacitor 21 or the voltage of the second capacitor 22 exceeds the allowable voltage value. The voltage of the first capacitor 21 is the value detected by the first voltage sensor 41. The voltage of the second capacitor 22 is the value detected by the second voltage sensor 42. The allowable range and allowable voltage values may be set based on, for example, the withstand voltage of the switch. In this embodiment, step S12 corresponds to the “determination unit”.

When a negative decision is made in step S12, the control device 40 proceeds to step S13. In step S13, the control device 40 performs the normal process. In the normal process, the control device 40 identifies which of the first to sixth sectors the command voltage vector Vm exists in, and which of the first to fourth division areas R1 to R4 is the area where the command voltage vector Vm exists. In step S14, a group of output voltage vectors corresponding to the control points at the vertices of the division area where the command voltage vector Vm exists is set as the output pattern.

In step S15, the control device 40 calculates the output period of each of the output voltage vectors included in the output pattern. The control device 40 decomposes the command voltage vector Vm into the output voltage vectors included in the output pattern. In this case, when the output voltage vectors corresponding to each of the control point M, N are included, one of the Hi-Mid drive state or the Mid-Lo drive state is selected based on the neutral point information, and the selected drive state is used. The control device 40 calculates the output period in one modulation cycle of the corresponding output voltage vector based on the magnitude of the decomposed output voltage vector. In step S16, the control device 40 generates the drive commands to turn on and off each switch SUH to SWL and QU to QW based on the calculated output period of each of the output voltage vectors. In this embodiment, steps S15 and S16 correspond to the “control unit”.

On the other hand, when a positive judgment is made in step S12, the control device 40 proceeds to step S17. In step S17, the control device 40 identifies the sector in which the command voltage vector Vm exists based on the electrical angle de of the command voltage vector Vm. In the following steps S18 to S35, the control device 40 uses the angle θs of the command voltage vector Vm within the sector identified in step S17. The angle θs in the sector is an angle between the command voltage vector Vm and the line segment PB in FIG. 6 and takes values from 0° to 60°. The angle θs within the sector is calculated from the electrical angle θe of the command voltage vector Vm and the information of the sector number where the command voltage vector Vm exists.

In step S18, the control device 40 determines whether the command voltage vector Vm is in the first division area R1. The control device 40 determines whether the command voltage vector Vm is in the first division area R1 based on information in which the size of the command voltage vector Vm and the angle in the sector θs is corresponded to the first division area R1 (specifically, map information or formula information). When a positive judgment is made in step S18, control device 40 proceeds to step S13. On the other hand, if a negative judgment is made in step S18, control device 40 proceeds to step S19.

In step S19, the control device 40 determines whether the angle θs in the sector is smaller than 30°. In step S19, the control device 40 determines whether the end point of the command voltage vector Vm is in the control points B, N side relative to the line segment PQ in FIG. 6. When a positive judgment is made in step S19, the control device 40 proceeds to step S20.

In step S20, control device 40 determines whether |Vm|×cos(60°−θs)>VH/3 is satisfied. Here, |Vm| is the magnitude of the command voltage vector Vm. VH/3 is half of the voltage value that can be output as each phase-voltage. In step S20, the control device 40 determines whether the end point of the command voltage vector Vm is in the area in the control points A, Q side relative to the line segment BM in FIG. 6. When a positive judgment is made in step S20, control device 40 proceeds to step S21. In step S21, the control device 40 identifies that the command voltage vector Vm is in the eighth division area R8. On the other hand, when a negative judgment is made in step S20, the control device 40 proceeds to step S22.

In step S22, the control device 40 determines whether |Vm|×cos(θs)<VH/3 is satisfied. In step S22, the control device 40 determines whether the end point of the command voltage vector Vm is in the control points M, P side relative to the line segment AN in FIG. 6. When a positive judgment is made in step S22, control device 40 proceeds to step S23. In step S23, the control device 40 identifies that the command voltage vector Vm is in the fifth division area R5. On the other hand, when a negative judgment is made in step S22, the control device 40 proceeds to step S24. In step S24, the control device 40 identifies that the command voltage vector Vm is in the sixth division area R6.

When a negative decision is made in step S19, the control device 40 proceeds to step S25. In step S25, the control device 40 determines whether |Vm|×cos(θs)>VH/3 is satisfied. In step S25, the control device 40 determines whether the end point of the command voltage vector Vm is in the control points B and Q side relative to the line segment AN in FIG. 6. When a positive judgment is made in step S25, the control device 40 proceeds to step S26. In step S26, the control device 40 identifies that the command voltage vector Vm is in the 9th division area R9. On the other hand, when a negative judgment is made in step S25, the control device 40 proceeds to step S27.

S27, control device 40 determines whether the In step |Vm|×cos(60°−θs)<VH/3 is satisfied. In step S27, the control device 40 determines whether the end point of the command voltage vector Vm is in the control points N, P side relative to the line segment BM in FIG. 6. When a positive judgment is made in step S27, the control device 40 proceeds to step S28. In step S28, the control device 40 identifies that the command voltage vector Vm is in the fifth division area R5. On the other hand, when a negative judgment is made in step S27, the control device 40 proceeds to step S29. In step S29, the control device 40 identifies that the command voltage vector Vm is in the seventh division area R7. In this embodiment, the processing of steps S17 to S29 corresponds to the “area identification unit”.

When the command voltage vector Vm is identified as being in the eighth division area R8 in step S21, the control device 40 proceeds to step S30. In step S30, the control device 40 sets the group of output voltage vectors corresponding to the eighth division area R8 as an output pattern. Specifically, the control device 40 sets a group of output voltage vectors corresponding to each of the control point A, B, N as an output pattern. In this case, the output pattern is limited to include the output voltage vector corresponding to control point Q.

When the command voltage vector Vm is identified as being in the fifth division area R5 in step S23, the control device 40 proceeds to step S31. In step S31, the control device 40 sets the group of output voltage vectors corresponding to the fifth division area R5 as an output pattern. Specifically, the control device 40 sets the group of output voltage vectors corresponding to each of the control points M, N, Q as the output pattern.

When the command voltage vector Vm is identified in step S24 as being in the sixth division area R6, the control device 40 proceeds to step S32. In step S32, the control device 40 sets the group of output voltage vectors corresponding to the sixth division area R6 as an output pattern. Specifically, the control device 40 sets a group of output voltage vectors corresponding to each of the control points B, M, N as an output pattern. In this case, the output pattern is limited to include the output voltage vector corresponding to control point Q.

When the command voltage vector Vm is identified in step S26 as being in the ninth division area R9, the control device 40 proceeds to step S33. In step S33, the control device 40 sets the group of output voltage vectors corresponding to the ninth division area R9 as an output pattern. Specifically, the control device 40 sets a group of output voltage vectors corresponding to each of the control points A, B, M as an output pattern. In this case, the output pattern is limited to include the output voltage vector corresponding to control point Q.

When the command voltage vector Vm is identified in step S28 as being in the fifth division area R5, control device 40 proceeds to step S34. The processing in step S34 is similar to the processing in step S31.

When the command voltage vector Vm is identified as being in the seventh division area R7 in step S29, the control device 40 proceeds to step S35. In step S35, the control device 40 sets the group of output voltage vectors corresponding to the seventh division area R7 as an output pattern. Specifically, the control device 40 sets a group of output voltage vectors corresponding to each of the control points A, M, N as an output pattern. In this case, the output pattern is restricted to include the output voltage vector corresponding to control point Q. After steps S30-S35, control device 40 proceeds to step S15. In this embodiment, the processing of steps S30 to S35 corresponds to the “setting unit”.

According to this embodiment detailed above, the following effects can be obtained.

When the neutral point O is connected to at least one of the input terminals of each phase of the motor 10, the voltage at the neutral point O can change as current flows into or out of the neutral point O. Therefore, during the period when the output voltage vector corresponding to control points M and N is output, the voltage at the neutral point O may change because of the connection between the neutral point O and one or two of the phase input terminals of each phase of the motor 10.

The output voltage vectors corresponding to the control points M and N includes output voltage vectors, in which the same voltage applied to input terminals of each phase of the motor 10, and the output voltage vectors corresponding to the Hi-Mid drive state and Mid-Lo drive state where the direction of change of the voltage at the neutral point O is opposite. Therefore, it is possible to control the voltage at neutral point O by appropriately selecting one of the Hi-Mid and Mid-Lo drive states based on the neutral point information.

However, when the magnitude of the command voltage vector Vm is large, the period during which the output voltage vector corresponding to each of the control points M and N is output can be shorter and the period during which the output voltage vector corresponding to the control point Q can be longer than when the magnitude of the command voltage vector Vm is small. The output voltage vector corresponding to the control point Q is an output voltage vector that is larger than the magnitude of the output voltage vectors corresponding to each of the control points M and N. During the output period of the output voltage vector corresponding to the control point Q, there is a concern that the controllability of the voltage at neutral point O is reduced because of the connection between neutral point O and any one of the phases of the input terminals of each phase of the motor 10.

Therefore, when setting the output pattern, which is a combination of each of the output voltage vector, based on the command voltage vector Vm, this embodiment limits the output voltage vector corresponding to the control point Q to be included in the output pattern. This suppresses the occurrence of periods when the output voltage vector corresponding to the control point Q is output. In the period when the output voltage vector corresponding to one of the control points M and N is output, by selecting one of the Hi-Mid drive state and Mid-Lo drive state based on the neutral point information, the voltage at the neutral point O is well-controlled. Therefore, this embodiment can suppress the change in the voltage of neutral point O during the period when the output voltage vector corresponding to each of the control points M, N, Q is output. In other words, according to this embodiment, it is possible to take measures to suppress changes in the voltage of the neutral point O during the output period of the output voltage vector corresponding to each of the control points M, N, Q, where there is concern that the voltage of the neutral point O may change. As a result, the controllability of the voltage at neutral point O is improved.

In the case where the output voltage vector corresponding to the control point Q is limited to be included in the output pattern, the output pattern is a combination of the output voltage vectors corresponding to the control points A, B, M, and N respectively. In this case, to improve the controllability of the voltage at the neutral point O, the output period of the output voltage vectors corresponding to the control points M and N respectively should be lengthened. On the other hand, when the magnitude of the command voltage vector Vm is increased, the controllability of the inverter 30 may be reduced.

This embodiment identifies the existence area of the command voltage vector Vm based on the magnitude of the command voltage vector Vm and the electrical angle θe. The existence area includes the seventh division area R7 and the ninth division area R9, which are bordering to the control point A, and the sixth division area R6 and the eighth division area R8, which are bordering to the control point B. The method of setting the output pattern including the output voltage vector corresponding to each of the control points A, B, M, and N is changed according to which of the sixth to the ninth divisional areas R6 to R9 is the existence area of the command voltage vector Vm.

In detail, when the command voltage vector Vm is identified to be in the sixth or the seventh division area R6 or R7, the output voltage vector corresponding to the control point M, the output voltage vector corresponding to the control point N, and the output voltage vector corresponding to one of the respective control points A and B are set. In this case, compared to the case where the output pattern is set that includes the output voltage vector corresponding to one of the control points M and N, the output voltage vector corresponding to the control point A, and an output voltage vector corresponding to the control point B, the period during which the Hi-Mid drive state or the Mid-Lo drive state can be selected is longer. This allows for better control of the voltage at neutral point O.

On the other hand, when the command voltage vector Vm is identified to be in the eighth or ninth divisional area R8 or R9, the output voltage vector corresponding to one of the respective control points M and N, the output voltage vector corresponding to the control point A, and the output voltage vector corresponding to control point B, the output A pattern is set. In this case, the average size of the output voltage vector in one modulation cycle can be larger than when the output pattern is set that includes the output voltage vector corresponding to one of the control points A and B, the output voltage vector corresponding to the control point M, and the output voltage vector corresponding to the control point N. This allows the increase in the magnitude of the command voltage vector Vm to be handled. Therefore, the reduction in controllability of the inverter 30 is suppressed. As described above, according to this embodiment, the controllability of the voltage at the neutral point O can be improved while the reduction in controllability of the inverter 30 is suppressed.

There is concern that the controllability of the inverter 30 may be reduced due to excessive limitation process, such as limitation process being performed in situations where there is no problem with the voltage at the neutral point O. In this regard, in this embodiment, whether the limitation process is performed is determined based on the neutral point information. Specifically, when it is determined that the voltage at the neutral point O exceeds the allowable range, the limitation process is performed. On the other hand, when the voltage at neutral point O is not determined to exceed the allowable range, the normal process is performed. As a result, the limitation process is performed in situations where it is necessary to suppress changes in the voltage at the neutral point O. Therefore, the controllability of the voltage at the neutral point can be improved while suppressing the reduction of controllability of the inverter 30.

### Second Embodiment

The second embodiment is described below with reference to the drawings, focusing on the differences from the first embodiment.

In this embodiment, when the command voltage vector Vm is identified to be in the eighth or the ninth division area R8 or R9, the output pattern, which is a combination of the one output voltage vector corresponding to one of each of the control point M, N, the one output voltage vector corresponding to the control point A, and the one output voltage vector corresponding to the control point B, is set.

During the period when the output voltage vector corresponding to the control point A and the output voltage vector corresponding to the control point B are output, the phase-voltage of level H or level L is applied to the input terminals of each phase of the motor 10. In other words, during the period when the output voltage vector corresponding to the control point A and the output voltage vector corresponding to the control point B are output, the phase-voltage of level M is not applied to the input terminals of each phase of the motor 10. Therefore, when switching the drive state from the drive state corresponding to one of the output voltage vectors corresponding to the control point A and the output voltage vector corresponding to the control point B to the other, without going through the period when the phase-voltage of level M is applied, each upper/lower arm switches SUH to SWL are turned on and off. In this case, there is a concern that the surge voltage generated when switching each upper/lower arm switch SUH to SWL on and off may increase.

Therefore, the control is changed compared with the first embodiment when the command voltage vector Vm is identified to be in the eighth or the ninth division area R8 or R9. FIG. 15 shows the control procedure performed by the control device 40. This control may be performed repeatedly, for example, at a predetermined control cycle.

After processing steps S30 and S33, the control device 40 proceeds to step S40. In step S40, the control device 40 adds the output voltage vector corresponding to the control point Q to the output pattern. In step S41, the control device 40 acquires switch information regarding the time required for each clamp switch QU to QW to be turned on and off. The switch information is information indicating the electrical characteristics of each clamp switch QU to QW, specifically, the gate threshold voltage, turn-on delay time and turn-off delay time. For example, in step S41, the control device 40 can acquire the switch information stored in the memory of the control device 40. In this embodiment, steps S30-S35 and step S40 correspond to the “setting unit” and step S41 corresponds to the “switch information acquisition unit”.

In step S42, the control device 40 calculates the output period of each of the output voltage vectors in the output pattern. The method of calculating the output period of the output voltage vector corresponding to the control point Q is explained below. From the viewpoint of suppressing changes in the voltage at the neutral point O, it is desirable that the output period of the output voltage vector corresponding to the control point Q be shortened. However, if the output period of the output voltage vector corresponding to the control point Q is shorter than the time required to turn on/off each of the clamp switches QU to QW, the output period of the output voltage vector corresponding to the control point Q will end before each of the clamp switches QU, QW is actually turned on/off. In this case, there is a concern that the suppression effect of the surge voltage is reduced.

Therefore, the embodiment calculates the output period of the output voltage vector corresponding to the control point Q to be longer than the time required to turn on and off each of the clamp switches QU to QW, based on the acquired switch information. The upper limit of the output period of the output voltage vector corresponding to the control point Q should be within half of one modulation cycle Tc. For example, the upper limit of the output period of the output voltage vector corresponding to control point Q should be ⅙, 1/12 or 1/24 of one modulation cycle Tc, etc. In this embodiment, step S42 corresponds to the “calculation unit”.

In step S43, control device 40 generates the drive command to turn on and off each of the switches SUH to SWL and QU to QW so that during the switching from the output period corresponding to one of the output voltage vectors corresponding to the control point A and the output voltage vector corresponding to the control point B to the output period corresponding to the other, a period in which the output voltage vector corresponding to the control point Q is output is interspersed. In this embodiment, step S43 corresponds to the “control unit”.

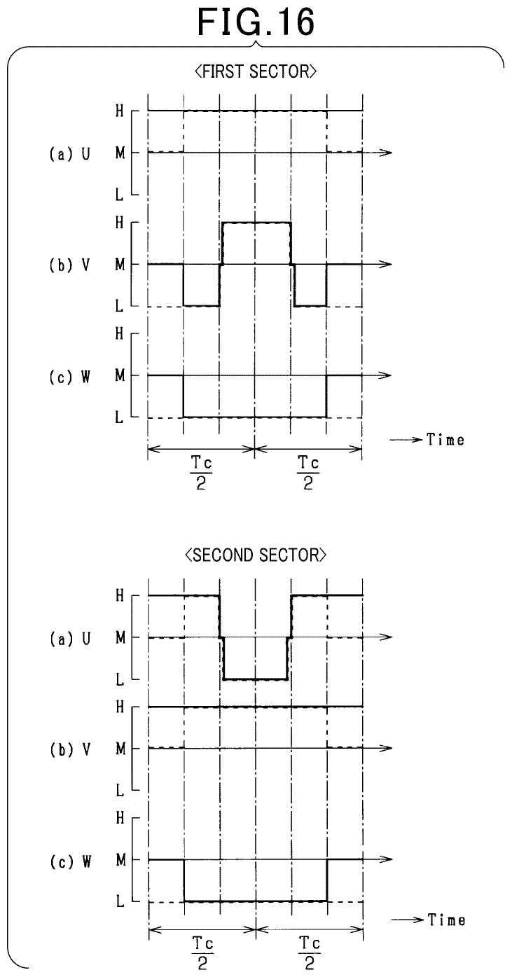

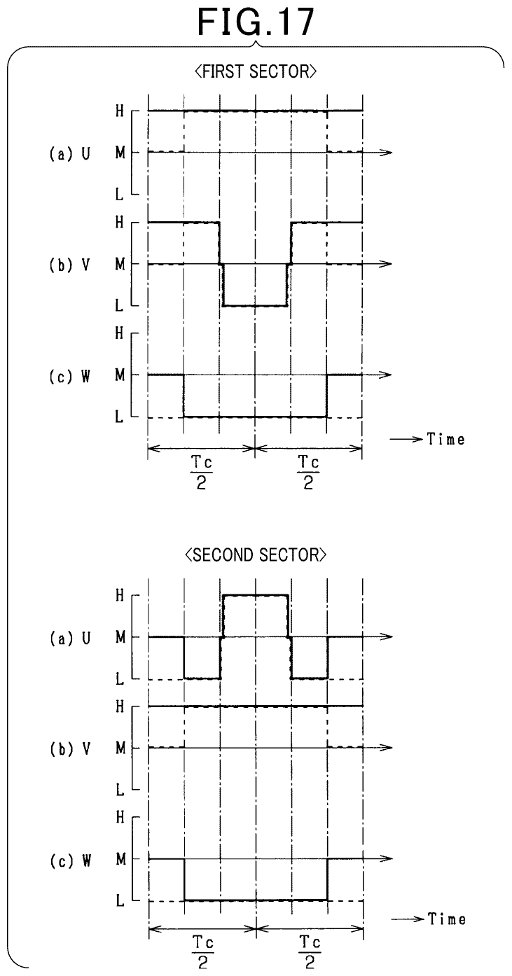

FIG. 16 shows an example of the transition of each of the phase-voltage levels when the command voltage vector Vm is identified as being in the eighth division area R8. FIG. 17 shows an example of the transition of each of the phase-voltage levels when the command voltage vector Vm is identified as being in the nineth division area R9. (a) to (c) part in FIG. 16 correspond to (a) to (c) part in FIG. 12, and (a) to (c) part in FIG. 17 correspond to (a) to (c) part in FIG. 13.

When the command voltage vector Vm is in the eighth division area R8 of the first sector or the second sector, depending on whether the Hi-Mid or Mid-Lo drive state is selected, the output voltage vector in the first half of one modulation cycle Tc is in the following order. When the Hi-Mid drive state is selected in the first sector, the output voltage vectors are output in the order of HMM, HLL, HML, and HHL. When the Hi-Mid drive state is selected in the second sector, the output voltage vectors are output in the order of HHM, HHL, MHL, and LHL. In these cases, the transition of each of the phase-voltage levels becomes the transition shown by the solid line in FIG. 16. When the Mid-Lo drive state is selected in the first sector, the output voltage vectors are output in the order of MLL, HLL, HML, and HHL. When the Mid-Lo drive state is selected in the second sector, the output voltage vectors are output in the order MML, HHL, MHL, and LHL. In these cases, the transition of each of the phase-voltage levels becomes the transition shown by the dashed line in FIG. 16.

When the command voltage vector Vm is in the 9th division area R9 of the first sector or the second sector, depending on whether the Hi-Mid or Mid-Lo drive state is selected, the output voltage vector is output in the following order in the first half of one modulation cycle Tc. When the Hi-Mid drive state is selected in the first sector, the output voltage vectors are output in the order of HHM, HHL, HML, and HLL. When the Hi-Mid drive state is selected in the second sector, the output voltage vectors are output in the order of MHM, LHL, MHL, and HHL. In these cases, the transition of each of the phase-voltage levels becomes the transition shown by the solid line in FIG. 17. When the Mid-Lo drive state is selected in the first sector, the output voltage vectors are output in the order of MML, HHL, HML, and HLL. When the Mid-Lo drive state is selected in the second sector, the output voltage vectors are output in the order of LML, LHL, MHL, and HHL. In these cases, the transition of each of the phase-voltage levels becomes the transition shown by the dashed line in FIG. 17.

According to this embodiment detailed above, the following effects can be obtained.

When the command voltage vector Vm is identified as being in the eighth or ninth divisional area R8 or R9, the output voltage vector corresponding to the control point Q is added to the output pattern. In other words, the output pattern includes the output voltage vector corresponding to one of the control points M and N, the output voltage vector corresponding to the control point A, the output voltage vector corresponding to the control point B, and the output voltage vector corresponding to control point Q.

In the output pattern described above, the output period of the output voltage vector corresponding to the control point Q can be interspersed between switching from the output period corresponding to one of the output voltage vectors corresponding to the control point A and the output voltage vector corresponding to the control point B to the output period corresponding to the other. In this case, when switching from the output period corresponding to one of the output voltage vectors corresponding to the control point A and the output voltage vector corresponding to the control point B to the output period corresponding to the other, there is a period during which the phase-voltage of level M is applied. Therefore, the surge voltage generated when each upper/lower arm switch SUH to SWL is turned on/off is suppressed from increasing.

According to this embodiment, switch information regarding the time required to turn on/off each of the clamp switches QU to QW is acquired. Based on the switch information, the output period of the output voltage vector corresponding to the control point Q is calculated so that the output period of the output voltage vector corresponding to the control point Q is longer than the time required to turn on/off each of the clamp switches QU to QW. This ensures the period from the output of the output voltage vector corresponding to the control point Q to the actual on/off of each of the switches SUH to SWL, QU to QW appropriately. Therefore, the surge voltage generated when each upper/lower arm switch SUH to SWL is turned on and off can be accurately reduced.

### OTHER EMBODIMENTS

The above embodiment may be performed with the following modifications.

Instead of acquiring both the detection values of the first voltage sensor 41 and the second voltage sensor 42 and the detection value of the phase current sensor 43 as neutral point information, the control device 40 may acquire only one of them. For example, the control device 40 may acquire only the detection value of the first voltage sensor 41 and the detection value of the second voltage sensor 42. In this case, the control device 40 may calculate each phase current based on the detection values of the first voltage sensor 41 and the second voltage sensor 42. The control device 40 may calculate each phase current calculated using the detection values of the first voltage sensor 41 and the second voltage sensor 42 and the voltage at the neutral point O may be calculated based on the capacitance of the first capacitor 21 and the second capacitor 22. This allows steps S10 and S15 to be performed without using the detected values of the phase current sensors 43.

The division areas for limitation process are not limited to the first, fifth through ninth division areas R1, R5 through R9 shown in FIG. 6. For example, the division area may be changed by changing the ratio of the line segment PQ by point G to the end of the line segment PQ. Specifically, instead of point G being a point that divides line segment PQ into 2:1, it may be changed to a point that divides line segment PQ into 3:1. In this case, the eighth and ninth division areas R8, R9 are reduced in size compared to the first embodiment, and the sixth and seventh division areas R6, R7 are enlarged compared to the first embodiment. As a result, the division area where the output pattern, which is a combination of the output voltage vector corresponding to control point M, the output voltage vector corresponding to control point N, and the output voltage vector corresponding to one of the respective control points A and B, is set, is widened. Therefore, even when the magnitude of the command voltage vector Vm is large, the period during which the Hi-Mid drive state and Mid-Lo drive state can be selected can be extended compared to the first embodiment.

In this case, the processing of steps S19, S20, S22, S25, and S27 may be modified. For example, using information (e.g., map information) in which the magnitude and electrical angle de of the command voltage vector Vm and each division area R1, R5 to R9 for the first to sixth sectors are mapped, the process of identifying the division area where the command voltage vector Vm exists may be performed.

The drive object of the inverter 30 is not limited to the motor 10 in which each phase winding 11U, 11V, 11W is star-connected, but may be a motor in which each phase winding 11U, 11V, 11W is delta-connected. The drive object is not limited to motors but may be any other load with 3-phase windings.

Instead of a T-type three-level inverter, the inverter 30 may be a neutral point clamped three-level inverter.

The semiconductor switches that make up the inverter are not limited to N-channel MOSFETs, but maybe IGBTs, for example. In this case, the high potential side terminal of the switch is the collector, and the low potential side terminal is the emitter. In addition, each switch should have a freewheeling diode connected in reverse parallel.

The control section and its methods described in this disclosure may be realized by a dedicated computer provided by comprising a processor and memory programmed to perform one or more functions embodied by a computer program. Alternatively, the control section and methods described in this disclosure may be realized by a dedicated computer provided by configuring the processor with one or more dedicated hardware logic circuits. Alternatively, the control section and its methods described in this disclosure may be realized by one or more dedicated computers provided by a combination of a processor and memory programmed to perform one or more functions and a processor configured by one or more dedicated hardware logic circuits. The computer program may also be stored in a computer-readable non-transitory recording medium as instructions to be executed by a computer.

Although this disclosure has been described in accordance with examples, it is understood that this disclosure is not limited to said examples or structures. The present disclosure also encompasses various variations and transformations within the scope of equality. In addition, various combinations and forms, as well as other combinations and forms including only one element, thereof, also fall within the scope and concept of this disclosure.

What is claimed is:

1. A control device for a three-level inverter applied to a system, the system comprising:
a first battery and a second battery connected in series;
a motor with three-phase windings electrically connected to the three-level inverter and driven by three phases AC voltage; and
the three-level inverter including switches for three phases that connects each of configuration of the phases of the motor to one of a positive electrode of the first battery, a neutral point between a negative electrode of the first battery and a positive electrode of the second battery, and a negative electrode of the second battery,
wherein the control device comprises:
a neutral point information acquisition unit that acquires neutral point information;
a command voltage acquisition unit that acquires a command voltage vector to control a system output of the motor to approach a command value;
a setting unit that sets output patterns, which are combinations of output voltage vectors, each of the output voltage vectors indicating the phase-voltage for each of the three phases, that can be output by the three-level inverter, based on the command voltage vector; and
a control unit that turns each of the switches on and off based on the output voltage vectors included in the output patterns, wherein
the control unit selects one of the two switch drive states based on neutral point information when the three-level inverter outputs a first output voltage vector,
the setting unit limits a second output voltage vector to be included in the output pattern,
the neutral point information is at least one of a voltage of the first battery, a voltage of the second battery, and the current flowing in each phase of the motor,
the control device further comprises an area identification unit that identifies an area where the command voltage vector exists based on a magnitude and an electrical angle of the command voltage vector,
the area includes a high output area and a low output area, each of the high output area and the low output area bordering the endpoint of a third output voltage vector,
the setting unit, when the command voltage vector is identified as being in the high output area, set the output pattern that is a combination of the one first output voltage vector and the two third output voltage vectors, and when the command voltage vector is identified as being in the low output area, set the output pattern that is a combination of the two first output voltage vectors and the one third output voltage vector,
the first output voltage vector is an output voltage vector that occurs when the switches connect any one or two of the phases to the neutral point and when drive states of the switches is one of two different drive states when there are two different drive states for the same output voltage vector, and
the second output voltage vector is an output voltage vector that occurs when the switches connect any one of the phases and the neutral point, and larger than the magnitude of the first output voltage vector,
the third output voltage vector is an output voltage vector hat occurs when the switches do not connect any one of the phases to the neutral point and larger than the magnitude of the first output voltage vector,
the setting unit adds the second output voltage vector to the output pattern when the command voltage vector is identified as being in the high output area,
the control unit, during an output period of the third output voltage vector, controls the switches such that each phase to be driven is connected to the positive electrode of the first battery or the negative electrode of the second battery, and the control unit, when the second output voltage vector is added to the output pattern, controls the switches such that an output period of the second output voltage vector comes in the middle of a period in which the switches are turned on and off to change a driving status from a driving status in which one of the third output voltage vector is output to a driving status in which another one of the third output voltage vector is output.

2. The control device for the three-level inverter according to claim 1, further comprising:
a switch information acquisition unit that acquires switch information, the switch information being at least one of a gate threshold voltage of the switches, a turn-on delay time of the switches, and a turn-off delay time of the switches; and
a calculation unit that calculates, based on the switch information, the output period of the second output voltage vector such that the output period of the second output voltage vector is longer than the time required to turn the switches on and off.

3. The control device for the three-level inverter according to claim 1, further comprising a determination unit that determines whether the neutral point voltage exceeds the allowable range based on the neutral point information, and
wherein the setting unit limits the second output voltage vector to be included in the output pattern when it is determined that the voltage at the neutral point exceeds the allowable range, and does not limit the second output voltage vector to be included in the output pattern when it is not determined that the voltage at the neutral point exceeds the allowable range.

4. The control device for the three-level inverter according to claim 2, further comprising a determination unit that determines whether the neutral point voltage exceeds the allowable range based on the neutral point information, and
wherein the setting unit limits the second output voltage vector to be included in the output pattern when it is determined that the voltage at the neutral point exceeds the allowable range, and does not limit the second output voltage vector to be included in the output pattern when it is not determined that the voltage at the neutral point exceeds the allowable range.

5. A computer-readable non-transitory storage medium storing a program applied to a system, the system comprising:
a first battery and a second battery connected in series;
a motor with three-phase windings electrically connected to the three-level inverter and driven by three phases AC voltage;
the three-level inverter including switches for three phases that connects each of configuration of the phases of the motor to one of a positive electrode of the first battery, a neutral point between a negative electrode of the first battery and a positive electrode of the second battery, and a negative electrode of the second battery; and
a computer,
wherein the program causes the computer to execute:
a neutral point information acquisition step for acquiring neutral point information;
a command voltage acquisition step for acquiring a command voltage vector to control a system output of the motor to approach a command value;
a setting step for setting output patterns, which are combinations of output voltage vectors, each of the output voltage vectors indicating the phase-voltage for each of the three phases, that can be output by the three-level inverter, based on the command voltage vector; and
a control step for turning each of the switches on and off based on the output voltage vectors included in the output patterns, wherein
the control step includes selecting one of the two switch drive states based on neutral point information when the three-level inverter outputs a first output voltage vector,
the setting step includes limiting a second output voltage vector to be included in the output pattern,
the neutral point information is at least one of a voltage of the first battery, a voltage of the second battery, and the current flowing in each phase of the motor,
the program further causes the computer to execute an area identification step for identifying an area where the command voltage vector exists based on a magnitude and an electrical angle of the command voltage vector,
the area includes a high output area and a low output area, each of the high output area and the low output area bordering the endpoint of a third output voltage vector,
the setting step includes, when the command voltage vector is identified as being in the high output area, setting the output pattern that is a combination of the one first output voltage vector and the two third output voltage vectors, and when the command voltage vector is identified as being in the low output area, setting the output pattern that is a combination of the two first output voltage vectors and the one third output voltage vector,
the first output voltage vector is an output voltage vector that occurs when the switches connect any one or two of the phases to the neutral point and when drive states of the switches is one of two different drive states when there are two different drive states for the same output voltage vector, and
the second output voltage vector is an output voltage vector that occurs when the switches connect any one of the phases and the neutral point, and larger than the magnitude of the first output voltage vector,
the third output voltage vector is an output voltage vector hat occurs when the switches do not connect any one of the phases to the neutral point and larger than the magnitude of the first output voltage vector,
the setting step includes adding the second output voltage vector to the output pattern when the command voltage vector is identified as being in the high output area,
the control step includes, during an output period of the third output voltage vector, controlling the switches such that each phase to be driven is connected to the positive electrode of the first battery or the negative electrode of the second battery, and
the control step includes, when the second output voltage vector is added to the output pattern, controlling the switches such that an output period of the second output voltage vector comes in the middle of a period in which the switches are turned on and off to change a driving status from a driving status in which one of the third output voltage vector is output to a driving status in which another one of the third output voltage vector is output.

6. A control method for a three-level inverter applied to a system, the system comprising:
a first battery and a second battery connected in series;
a motor with three-phase windings electrically connected to the three-level inverter and driven by three phases AC voltage; and
the three-level inverter including switches for three phases that connects each of configuration of the phases of the motor to one of a positive electrode of the first battery, a neutral point between a negative electrode of the first battery and a positive electrode of the second battery, and a negative electrode of the second battery;
wherein the method comprising:
a neutral point information acquisition step for acquiring neutral point information;
a command voltage acquisition step for acquiring a command voltage vector to control a system output of the motor to approach a command value;
a setting step for setting output patterns, which are combinations of output voltage vectors, that can be output by the three-level inverter, based on the command voltage vector; and
a control step for turning each of the switches on and off based on the output voltage vectors included in the output patterns, wherein
the control step includes selecting one of the two switch drive states based on neutral point information when the three-level inverter outputs a first output voltage vector,
the setting step includes limiting a second output voltage vector to be included in the output pattern,
the neutral point information is at least one of a voltage of the first battery, a voltage of the second battery, and the current flowing in each phase of the motor, the method further comprises an area identification step for identifying an area where the command voltage vector exists based on a magnitude and an electrical angle of the command voltage vector,
the area includes a high output area and a low output area, each of the high output area and the low output area bordering the endpoint of a third output voltage vector,
the setting step includes, when the command voltage vector is identified as being in the high output area, setting the output pattern that is a combination of the one first output voltage vector and the two third output voltage vectors, and when the command voltage vector is identified as being in the low output area, setting the output pattern that is a combination of the two first output voltage vectors and the one third output voltage vector,
the first output voltage vector is an output voltage vector that occurs when the switches connect any one or two of the phases to the neutral point and when drive states of the switches is one of two different drive states when there are two different drive states for the same output voltage vector, and
the second output voltage vector is an output voltage vector that occurs when the switches connect any one of the phases and the neutral point, and larger than the magnitude of the first output voltage vector,
the third output voltage vector is an output voltage vector hat occurs when the switches do not connect any one of the phases to the neutral point and larger than the magnitude of the first output voltage vector,
the setting step includes adding the second output voltage vector to the output pattern when the command voltage vector is identified as being in the high output area,
the control step includes, during an output period of the third output voltage vector, controlling the switches such that each phase to be driven is connected to the positive electrode of the first battery or the negative electrode of the second battery, and
the control step includes, when the second output voltage vector is added to the output pattern, controlling the switches such that an output period of the second output voltage vector comes in the middle of a period in which the switches are turned on and off to change a driving status from a driving status in which one of the third output voltage vector is output to a driving status in which another one of the third output voltage vector is output.
